(19) United States
(12) Patent Application Publication
(10) Pub. No.: US 2008/0215409 A1
(43) Pub. Date: Sep. 4, 2008

(54) ITERATIVE RESOURCE SCHEDULING

(75) Inventor: Brian C. Van Matre, Louisville, CO (US)

Correspondence Address: HOGAN & HARTSON LLP, ONE TABOR CENTER, SUITE 1500, 1200 SEVENTEENTH ST, DENVER, CO, 80202, US

(73) Assignee: Victorware, LLC, Louisville, CO (US)

(21) Appl. No.: 11/966,756

(22) Filed: Dec. 28, 2007

Related U.S. Application Data
(60) Provisional application No. 60/883,162, filed on Jan. 3, 2007.

(51) Int. Cl. G06Q 10/00

(52) U.S. Cl. 705/8

(57) ABSTRACT

A request is received to accomplish a task by using a plurality of resources. Once the task is received, attributes of the resources are retrieved from a memory including constraints associated with those resources. These constraints can include hard constraints and soft constraints. A first schedule is then created using a subset of the plurality of resources that complies with each task and resource hard constraint. A score based on the degree of compliance of each soft constraint is determined for the first schedule score. Thereafter the first schedule is modified to form a second schedule, again complying with each hard constraint. A second schedule score is determined associated with the second schedule. These scores are compared so as to determine and select the more optimal schedule. The process continues iteratively until modifications of the schedule no longer yield an improving schedule.

### RELATED APPLICATION

The present application relates to and claims priority to U.S. Provisional Application No. 60/883,162 filed Jan. 3, 2007, the entirety of which is incorporated by this reference.

### BACKGROUND OF THE INVENTION

1. Field of the Invention

Embodiments of the present invention relate, in general, to systems and methods for iterative scheduling and particularly to schedule generation based on iterative techniques to optimize resource requirements.

2. Relevant Background

Numerous scheduling products exist to assist in the scheduling and management of resources. A schedule is in essence a planned use of resources to accomplish one or more tasks. These resources often have limited availability, and creating an efficient and effective planned use of these resources to accomplish a specific task has long been valued. The spectrum of scheduling aids is vast. At one end of the spectrum is project scheduling software that handles complex tasks spanning days, weeks, and months and allows tight control of tasks and resources on those time scales. At the other end of the spectrum are shift schedulers. Shift scheduling typically allows for a very coarse granularity of time scale and extremely simplistic algorithms for determining qualifications or suitability of people and resources for a task. In between are products of various capabilities that are typically targeted at a specific market or industry focus.

Lacking in the current art are scheduling programs or systems that allow for designation of arbitrary timing constraints constituting a “critical path” for short term schedules. A critical path is the lynch pin of a schedule. It is the path or resource utilization on which the rest of the schedule depends. These short term scheduling products also fail to accommodate complex methods of designating the qualifications that a person must have to be considered qualified for a task. And while many of the current scheduling products are capable of dealing with hard resource requirements, none allow for the designation of multiple soft constraints that in aggregate differentiate the optimality of potential schedules.

### SUMMARY OF THE INVENTION

Systems and methods for iteratively creating an optimal schedule of resources to accomplish a given task are hereafter disclosed. According to one embodiment of the present invention, a request is received to accomplish a task by using a plurality of resources. Once the task is received, attributes of the resources and the assigned task are retrieved from a memory including constraints that may limit these attributes. These constraints can include hard constraints and soft constraints. A first schedule is then created using a subset of the plurality of resources that complies with each task and resource hard constraint. A score based on the degree of compliance of each soft constraint is determined for the first schedule score. Thereafter the first schedule is modified to form a second schedule, again complying with each hard constraint. A second schedule score is determined associated with the second schedule. These scores and compared so as to determine and select the more optimal schedule. The process continues iteratively until modifications of the schedule no longer yield an improving schedule.

The features and advantages described in this disclosure and in the following detailed description are not all-inclusive; many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of a preferred embodiment taken in conjunction with the accompanying drawings, wherein:

FIG. 1 shows a high level block diagram of an iterative scheduling system according to one embodiment of the present invention;

FIG. 2 shows, according to one embodiment of the present invention, a directed graph implementing a hard constraint checking process;

FIG. 3 shows a flowchart of one method embodiment for iteratively creating a schedule to meet a task request, according to the gradient descent optimization process of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

An iterative schedule system provides an optimal solution to resource management. Embodiments of the present invention provide a builder engine that meets both hard task and resource requirements as well as optimizing soft constraints. According to one embodiment of the present invention, a task request identifies both hard and soft constraints. Hard constraints include requirements that must be satisfied to meet the requested task while soft constraints are preferences that may lead to an optimal solution or schedule but will not, if not complied with, result in a failed schedule. The present invention solves a requested task by first complying with all of the hard constraints and then iteratively modifies resource parameters to arrive at an optimal schedule.

Specific embodiments of the present invention are hereafter described in detail with reference to the accompanying Figures. Like elements in the various Figures are identified by like reference numerals for consistency. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

Before describing various embodiments of the present invention, it is useful to define and understand several key terms. A “directory” contains information about all people under control of the scheduling software. The specific information maintained in the directory is configurable and includes at least a unique resource identifier for use within the scheduling system. In many cases this identifier can include, when the resource is a person, the person's full name and an informal name.

The possible “qualifications” that a resource or person can hold are identified in one embodiment by a short character string, along with an optional description. For example, each person in the directory can hold zero or more qualifications. Qualifications have the effect of making a resource a candidate for being scheduled for a task, or removing that resource from consideration.

In general a “resource” is any entity subject to non-concurrent access scheduling, i.e. a resource being scheduled for one task makes it unavailable for being scheduled to another task in the same or an overlapping time period. A person can be considered a resource but, as will be described later, a person often is associated with a complex list of hard and soft constraints.

A “resource pool” is an aggregation of similar resources, any one of which has the ability to satisfy a resource requirement placed on a task. A task can thus require a specific resource (“Truck number 17A”) or it could require a resource from a pool (“a delivery truck”). A resource pool is a method of aggregating resources according to user specified criteria. An “availability restriction” is a restriction on the availability of a person or resource that occurs outside of the direct control of the schedule builder. Tasks that an individual or resource is scheduled to perform, according to an embodiment of the present invention, do not constitute availability restrictions. An availability restriction is a means of excluding a person or resource from consideration for all schedule tasks during a specific time period.

“Schedules” are the discrete units of time that are selected by the user to be built in one operation of the schedule building engine. Where time is continuous, and operations that are scheduled might be ongoing, a schedule is a finite period of time selected by the user within the continuing operation. A “task” is a finite, non-zero duration item to be scheduled by the schedule building engine. A task can have a fixed time, or it can be flexible. A task can require any number of attendee groups. For each attendee group, a minimum number of required people must be specified. In addition a task can specify that any number of specific non-human resources or pooled resources are required. Thus a schedule generated by the schedule building engine addresses a task. An “event” is a zero duration item that is designated as part of a schedule. Once an event is designated, timing requirements can be specified relative to it. Events do not have people or resources required, and are used primarily for allowing relative timing requirements to be specified.

A “timing requirement” can be specified for any task or event and can be relative to any other task, event, or to a specific time. Embodiments of the present invention allow maximum flexibility in designating timing requirements to include specifying according to task end or task start and specifying with arbitrary time modifiers, i.e. TASK A must start at least 45 minutes after TASK B finishes.

A “required attendee group” designates the people who are required to be scheduled for a given task. A required attendee group can be designated by name (either exclusively or inclusively) or by qualification (both exclusively or inclusively and with set theoretic and/or operators chaining qualifications). For example, a particular meeting might require that all people with the qualification “MANAGER” or “SENIOR SALES” attend. A required attendee group can be considered a hard constraint.

Numerous “soft constraints” can be specified in the schedule definition process that affect the outcome of the schedule build process. Violation of a soft constraint does not cause the schedule build process to fail (as does violation of a hard constraint), but rather a relative weight is assigned to the constraint that influences the overall suitability score of a particular schedule. The Score Calculator module of the Builder Engine (described below) utilizes the weight associated with each soft constraint in order to assign a rating to a schedule. Schedules that violate soft constraints the least are assigned greater ratings.

Among the soft constraints that are allowed to be specified within the software product are the following: 1) time normalization priority—the relative importance that automatically scheduled items begin on “standard” minutes, such as on the hour, half-hour, or quarter-hour; 2) preferential use/non-use of people and resources; 3) limitations to duty day, such as maximum consecutive on-duty time and minimum off-duty time between scheduled tasks; 4) preferred shift start times for people; 5) maximizing qualified attendees, (for example force a hard constraint of 2 people to perform a task, but then specify a soft constraint that 8 qualified people should be scheduled if possible, with a relative priority weight on the number of people between 3 and 8); 6) task timing, i.e. schedule a task as early or late as possible, or schedule it between times with a specified priority; and 7) preferred number of shifts per schedule period.

Embodiments of the present invention also can use templates. A “template” is a shortcut to creating a schedule, conceived of to ease the task of data entry. There are templates for each aspect of the schedule creation process. For example, there could be a “default line worker” template, a “default manager” template, etc., that could be defined and would simplify the task of data entry when it comes to adding people to the directory. Templates can be created for people, schedules, tasks, required attendees, and timing requirements, and are used to aid in the data entry process.

The use of templates coupled with the use of “Events”, “Tasks”, and “Timing Requirements”, as applied to an embodiment of the present invention and described previously, also creates a synergistic effect for many foreseen applications of the invention. These concepts taken together allow a template to be created in which all timing can be specified relative to some set of occurrences that are outside the control of the scheduling agency. Often the precise timing of these occurrences is not known sufficiently far in advance to allow longer range planning, but nonetheless they form part of the critical path for the schedule with which they are concerned. Further, the timing of these occurrences is often the primary difference between subsequent scheduling efforts, i.e. a schedule for one time period may differ from a schedule covering another time period primarily because the specific times of these key occurrences differs. A receiving department, for example, might base a substantial amount of its schedule on the arrival of inbound shipments, which are not known far in advance, and which are not controlled by the department. Using an embodiment of the present invention, the department would construct a template where Events exist for the major inbound shipment arrival times, and all other tasks (unloading, processing, inventory updating, distribution, etc.) are scheduled relative to these key Events. When the specific times for the shipments are known, the timing of the entire schedule can be determined by updating the key Event times and invoking the Builder Engine module. Subsequent schedules can also be generated by applying the same template and modifying only the key Event times.

According to one embodiment of the present invention, a user interface is comprised of numerous modules. These modules include a task builder module, an availability management module, a directory manager module, a global settings module, a resource management module, and a schedule manager.

The task builder module provides an interface for the user to define a task that must be accomplished during the schedule period. According to one embodiment of the present invention, a user is provided options to specify timing constraints, required attendee groups, resources required, associated soft constraints, and the like when forming a task.

The availability management module provides an interface to view and schedule availability restrictions for all people and resources under scheduling control. This module can also provide an interface for people to request time off and for the scheduler to view and approve these requests. Optionally, this module can be used by a resource manager to schedule downtime for resources under scheduling control.

The directory manager module provides an interface to add and remove resources from the directory. Adding a resource allows the scheduler to specify all scheduling preferences and soft constraints associated with the resource. The global settings module provides an interface for the scheduler to change settings with global scope, i.e. settings not associated with a particular task, schedule, person, or resource. These settings can include parameters and preferences that allow the user to tune behavior of the build process for a specific application. The resource management module interacts with the directory manager and provides an interface for adding and removing resources from control of the scheduling software.

The schedule manager provides an interface for creating a schedule and for adding tasks and events to it. The schedule manager module accesses and interacts with the task builder module to develop a complete definition of a schedule to build. In addition, this module provides the ability to direct that a schedule be built.

One aspect of the present invention allows resource data and other information in support of the scheduling process to be stored in persistent memory. Generally persistent memory is comprised of a relational database and a mechanism to access said database. This can include a relational database that can support transactions and multiple simultaneous connections adequate for the present invention. As can be appreciated by one skilled in the art of data storage, this can include third party software components to access the database in an efficient manner.

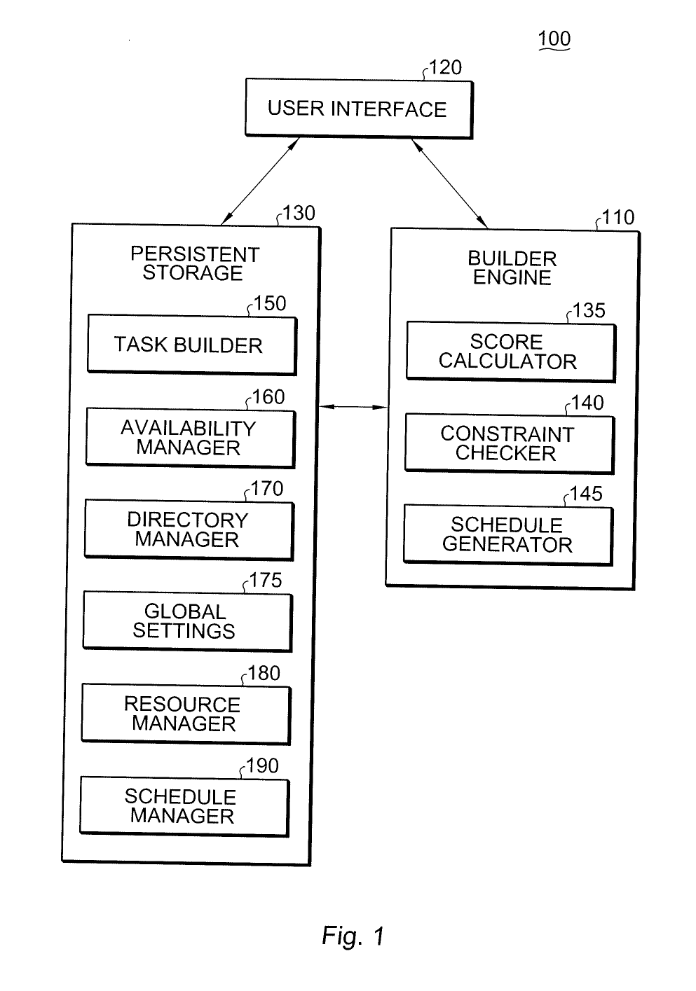

FIG. 1 shows a high level block diagram of an iterative scheduling system 100 according to one embodiment of the present invention. The scheduling system 100 includes a builder engine 110, a user interface 120, and persistent storage or memory 130. The builder engine 110, user interface 120, and persistent storage 130 interact to create an optimal schedule based on an iterative process.

According to one embodiment of the present invention, the builder engine includes a score calculator module 135, a constraint checker module 140, and a schedule generator module 145. The score calculator module 135 rates a schedule according to how well it satisfies the soft constraints placed upon the schedule. It interacts with the schedule generation module 145 to rank candidate schedules and select the most promising for further optimization or as the final selected schedule for publication.

The constraint checking module 140 interacts with both the score calculator 135 and the schedule generator 145 and evaluates candidate schedules for compliance with hard scheduling constraints, i.e. to determine if a schedule complies with every hard constraint and is positioned for further consideration. Evaluation of a critical path is accomplished by this module. A critical path is the longest path of planned activities to the end of the project or task and the earliest and latest that each activity can start and finish without making the project longer. This process determines which activities are “critical” (i.e., on the longest path) and which have “total float” (i.e., can be delayed without making the project longer). A critical path is the sequence of project network activities that adds up to the longest overall duration, and it determines the shortest time possible to complete the task. Any delay of an activity on the critical path directly impacts the planned task completion date (i.e., there is no float on the critical path).

According to one embodiment of the present invention, the constraint checking module 140 constructs a directed graph wherein each node of the graph represents a task or time and each link represents a scheduling constraint. For example, TASK A and TASK B would be nodes in the graph, and a link between them could indicate a constraint such as “TASK B must finish at least 30 minutes before TASK A starts”. The constraint checker module 140 assembles a directed graph of such tasks and constraints and then executes on it a cycle finding algorithm. As the algorithm traverses the graph, each node is updated with its earliest and latest possible times relative to each other node in the graph. In this way, an impossible situation can be identified in a reasonable amount of time.

The schedule generation module 145 has, according to one embodiment of the present invention, two main functions. The first is to develop “legal” schedules (i.e., schedules that pass validation by the constraint checker module because they meet all hard constraints). The second is to optimize legal schedules. To accomplish these tasks, the module makes use of constrained optimization and gradient descent algorithms, described below.

The builder engine 110 interacts with the persistent storage 130 to retrieve resource information needed to generate a schedule. Within the persistent storage 130 exists a task the data required by the task builder module 150, an availability manager 160, a directory manager 170, global settings 175, a resource manager 180 and a schedule manager 190.

The schedule generation module 145 and the constraint checker module 140 use a plurality of algorithms to accomplish the schedule building task. These include the Hard Constraint Checking Process, the Evolutionary Optimization Process, the Gradient Descent Optimization Process, and the Probabilistic Schedule Build Process.

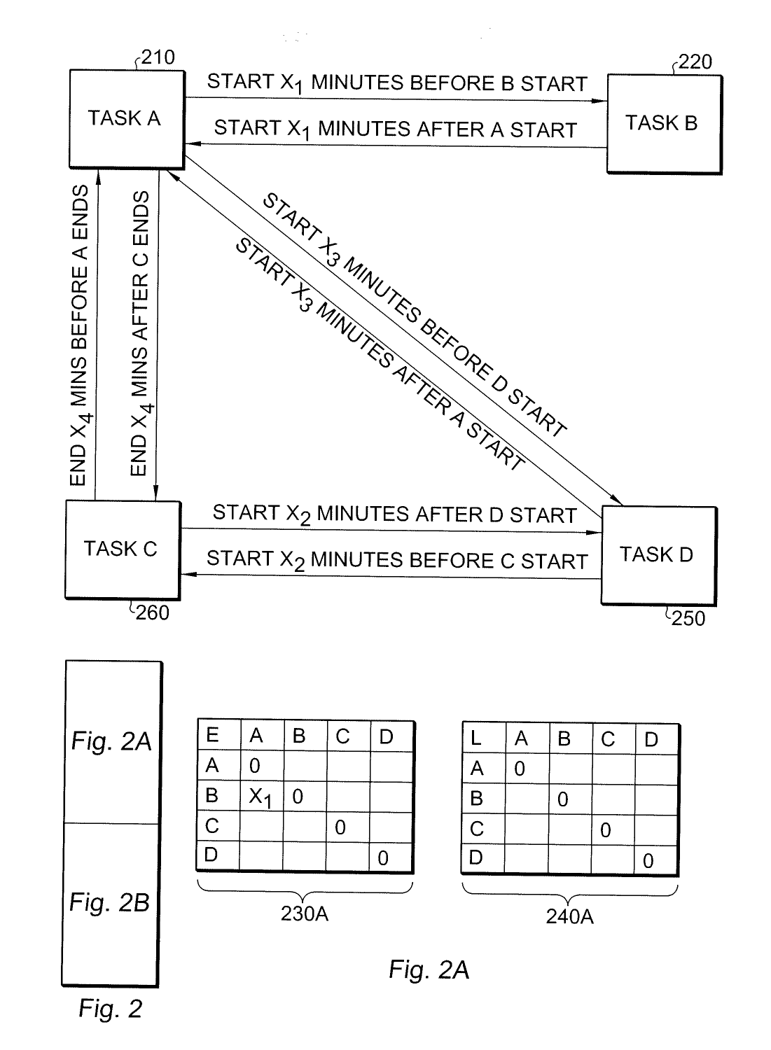

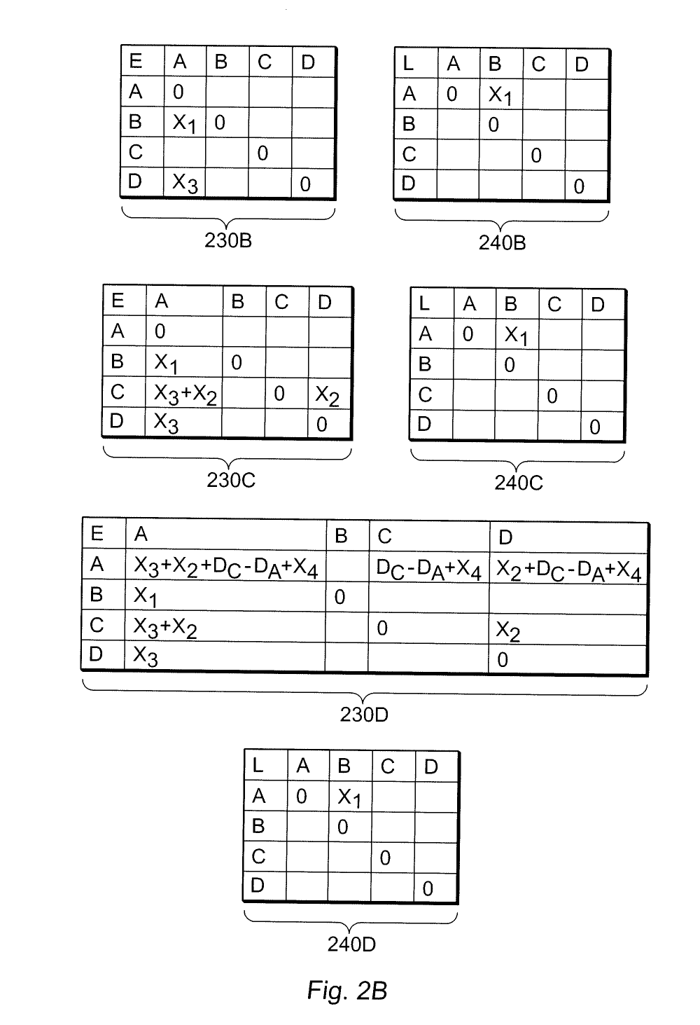

The Hard Constraint Checking Process is based on a Depth First Search (DFS) graph traversal algorithm, with at least one bookkeeping matrix to keep track of constraints. It is also possible to base the process on Breadth First Search (BFS). According to one implementation of the process two matrices are used. Both matrices are N by N (where N is the number of nodes) with one being used to track “Early” constraints and the other to track “Late” constraints. FIG. 2 shows a directed graph implementing a hard constraint checking process according to the present invention. Assume, for example, that the process will use the DFS as the underlying traversal mechanism, and that the process starts evaluating constraints at node A. An edge emanating from node A is selected.

In this example the edge to task B is chosen to traverse first. Upon traversal of this edge, the Early matrix 230a is updated as shown in FIG. 2 to indicate that task B 220 must start X₁ minutes after Task A 210 (or alternatively that task A 210 must start X₁ minutes before Task B 220). The next edge traversed is the symmetric link back to A 210. Since the process is proceeding along a “Later” constraint, a Late matrix 240a is similarly updated.

Assume that the next traversal is the link from Task A 210 to Task D 250 (alternatively any remaining link originating at Task A could be traversed next). Again the Early and Late matrix 230b, 240b respectively are updated. The process next chooses to traverse the edge from Task D 250 to Task C 260. Since the process travels on an earlier/before constraint, the Early matrix 230c is updated. Note that the early entry corresponding to Task C 260 indicates that Task C 260 must occur X₂+X₃ minutes before Task A 210. This is observed in the process by noting that Task D 250 already had a constraint relative to Task A 210, and thus in traversing from Task D 250 to Task C 260, the constraint to Task C 260 is propagated.

Next, the process chooses the edge to Task A 210. In this traversal the duration of the tasks, denoted with a “D” and the appropriate subscript, is taken into account. When traversing from Task C 260 to Task A 210, it is also necessary to update all constraints having a bearing on the situation, here represented by all fields in the “C” row of the Early matrix 230d which have a value in them. Note the Late matrix 240d remains unchanged.

It should also be noted that once we have traversed back to Task A 210, i.e. to a node that already exists in the path, the process checks whether any hard constraint has been violated. This is accomplished by looking at the Early entry corresponding to the Task and seeing if it is greater than zero. On the Late matrix, the examination is to see whether it is less than zero. In this example, observe that the Early entry for A is positive whenever:

X₃+X₂+D_{C}−D_{A}+X₄>0

The above inequality specifies criteria for when hard constraints are violated. In one embodiment of the present invention, all of the variables are known prior to invoking the constraint checking process. However one skilled in the art will recognize that an extension of this process to allow for unknown quantities, minimization, or maximization to optimize the unknown quantities and still have a legal schedule is within the scope of the present invention and is indeed contemplated. Prior to presenting a violating condition to a user, the process will further examine the path and remove any cycles reported in the path that do not affect the final outcome. In our example from FIG. 2, the process would report that the path A->D->C->A represents an impossible condition whenever the above inequality is met.

According to another embodiment of the present invention, an evolutionary optimization process is used by the builder engine to create an optimal schedule. The scheduling system 100 operates on legal schedules that have passed through the hard constraint checking process (i.e., in compliance with all hard constraints) in order to optimize the schedules in accordance with soft constraints specified by the user. There can be a multitude of soft constraints that a user can specify on a given schedule. For example, a user could specify that as many as possible qualified people attend a specific meeting. Further, the scheduler could designate some people as “restricted use”, where they are not to be utilized unless no other person can fill the position. As another example, the scheduler could designate that a particular task start as early as possible, or as late as possible, subject to hard constraints. Each of these soft constraints would be specified with a relative priority and indicated by an importance indicator. If selected by a user, the schedule building process would attempt to optimize the schedule subject to these soft constraints using the evolutionary optimization process.

According to one embodiment of the present invention, this process operates with entities representing legal schedules. Each generation consists of differentially mating the entities according to how well the schedule they would represent satisfies the soft constraints. Matching two entities consists of mixing the schedule features that they represent, with the possibility of mutating the features at each encounter. Each generation is also screened of schedules violating hard constraints. After some number of generations (iterations), the highest ranked match can be reported to the user, or it can be used as input to the Gradient Descent Optimization Process.

The Gradient Descent Optimization Process is one method of optimizing a schedule according to an embodiment of the present invention. In general, a gradient descent process is a method of minimizing a function by determining the multi-dimensional gradient at some starting point, and then making a move in the solution space in the direction of the minimum gradient. This step is iteratively repeated until no further improvement is possible (or until a maximum number of iterations is exceeded), i.e. a “local minima” is reached. It should be noted that a gradient ascent process proceeds analogously to gradient descent, but differs by seeking to maximize a function by proceeding in a direction of maximum gradient. For purposes of the present invention, the term “gradient descent” will be used as that is more common in the literature and any ascent problem can be equivalently restated as a descent problem. In the art of scheduling problems, however, the method must be modified somewhat as many of the dimensions in this domain are discrete and non-orthogonal. The number of shifts a particular person is scheduled for in a week, for example, can only take on natural numbers (zero and greater), and is tightly intertwined with the number of shifts or tasks for which other people are scheduled. Further, with scheduling problems, it can be prohibitively expensive or impossible to compute the maximum gradient at a given point in the solution space. Further, in this problem space the direction of maximum gradient may be ambiguous (i.e., multiple schedule alterations may result in an equivalent score). With allowances made for the specifics of the scheduling problem domain space, the gradient descent method is nonetheless applicable to this type of problem.

To start the Gradient Descent (or ascent) Optimization Process, an embodiment of the current invention may start with a schedule that meets all hard constraints, and may be the result of a linear programming method or some other optimization process. In this embodiment the schedule optimization process can be thought of as operating on a multi-dimensional surface, with a dimension for each potential schedule alteration that could be used in the optimization process. One or more dimensions would therefore be defined for each soft constraint specified by the scheduler user. The process works by sampling the local gradient and making changes to the schedule along one or more dimensions towards a maximal score. The gradient along any subset of dimensions is locally sampled by evaluating the current score and then evaluating the score of the schedule after some incremental move along one or more dimensions. In practice, using an embodiment of the current invention, it is often unnecessary to perform the sampling step. If, for example, there is a soft constraint to make Task A happen as early as possible and no other soft constraints on the timing of Task A, the sampling step would not be required as it is possible to determine a priori that a change making Task A happen earlier will result in a higher score, and is therefore a move towards a local maxima. Optimization is then accomplished by making changes along any or all of the dimensions in the sampled subset.

At each iteration of the Gradient Descent Optimization Process, an embodiment of the current invention may utilize the Probabilistic Schedule Build Process. To utilize this process, the embodiment first defines a finite list encompassing all possible types of modifications to the schedule. One such list may include: a) move the task to an earlier time; b) move the task to a later time; c) move the task to a specified time X; d) substitute resource Y for X (X being not currently scheduled for the task); and e) add another resource to accomplish the task, and remove a resource. In this embodiment of the current invention, each soft constraint on the schedule can be directly mapped to one or more sets of possible modifications to the schedule. An estimate for each possible set of modifications' probability of success is then generated from available information about the schedule to be modified. These probabilities are then normalized, such that the total of the estimated probabilities is exactly equal to one. Finally, one of the possible sets of modifications is selected according to its normalized probability of creating an improved schedule score. To take a simple example, if a task has a soft constraint to happen as early as possible, then in this embodiment of the current invention (with the list of possible modifications as described above) the soft constraint maps to exactly one set of one modification to the schedule—to attempt to make that task be scheduled earlier. For a more complex example, consider a soft constraint that a given resource be scheduled for between 4 and 6 shifts per week. If the current schedule has that resource scheduled for 3 shifts in a given week, the soft constraint would map to perhaps several different sets of possible modifications i.e., one for each different way the resource could be substituted for other resources to bring its shift total up to between 4 and 6 per week. Each of these sets of possible modifications would then be given an estimate of its probability of success. Factors weighing on this estimate might include the total number of modifications required in the set (and thus those sets bringing the total to 4 instead of 5 or 6 would have a higher probability associated with them), as well as the existence of an appropriate resource to remove from a given task in order to schedule the currently considered resource. Probabilistic preference here would be given to those substitutions where a comparable resource was allocated more than the desired number of shifts for the week. Next, the estimated probability of success for each potential set of modifications is normalized, so that the sum of the estimated probabilities over all potential sets is equal to one. From this set of possible sets, one set is selected according to its normalized estimated probability. In one embodiment of the current invention, at this stage the builder engine would generate a second schedule by applying all of the changes prescribed by the selected set of modifications in a single iteration. In another embodiment, each of the modifications in the set would be applied in separate iterations.

By using the Probabilistic Schedule Build Process as described above, an embodiment of the current invention avoids stagnation during the optimization process. By including an element of randomness to the process, the Builder Engine module will not become stuck attempting to repeatedly apply the same change or changes, which at first examination might seem to be very promising, but in reality causes no increase in overall schedule fitness. Further, the Probabilistic Schedule Build Process ensures that a broader area of the solution space is examined. Since the Gradient Descent Optimization Process is only guaranteed to find a local maxima, exploring more of the solution space increases the chances that the chosen local maxima is also global, especially when the entire process is repeated from the same or different initial schedules.

These and other implementation methodologies for schedule optimization can be successfully utilized by the schedule system 100. These implementation methodologies are known within the art, and the specifics of their application within the context of the present invention will be readily apparent to one of ordinary skill in the relevant art in light of this specification.

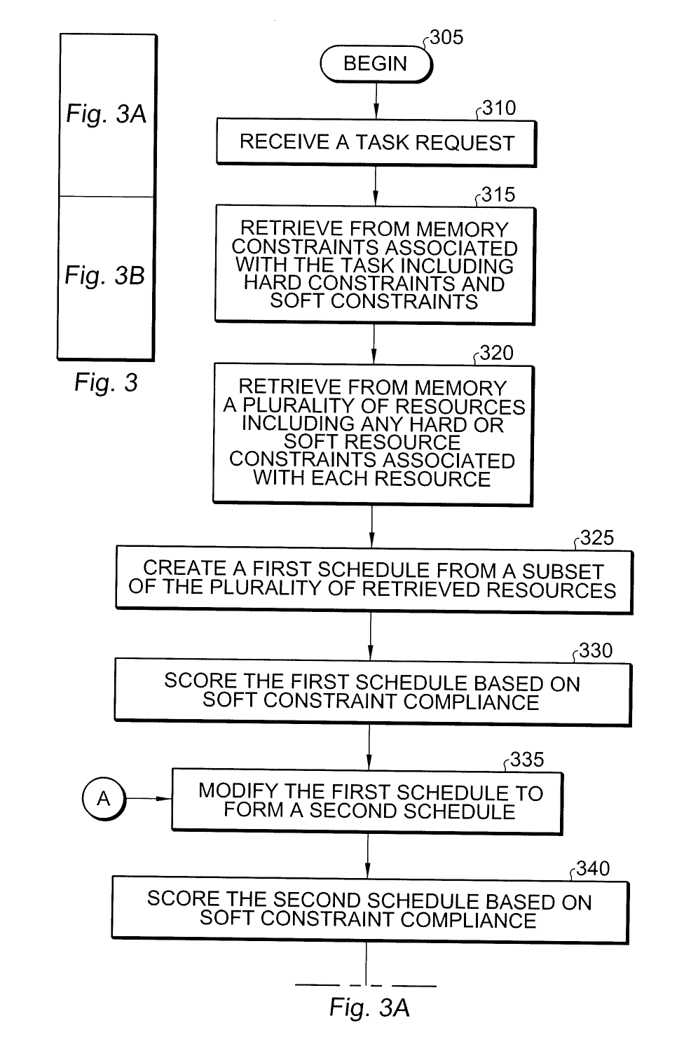

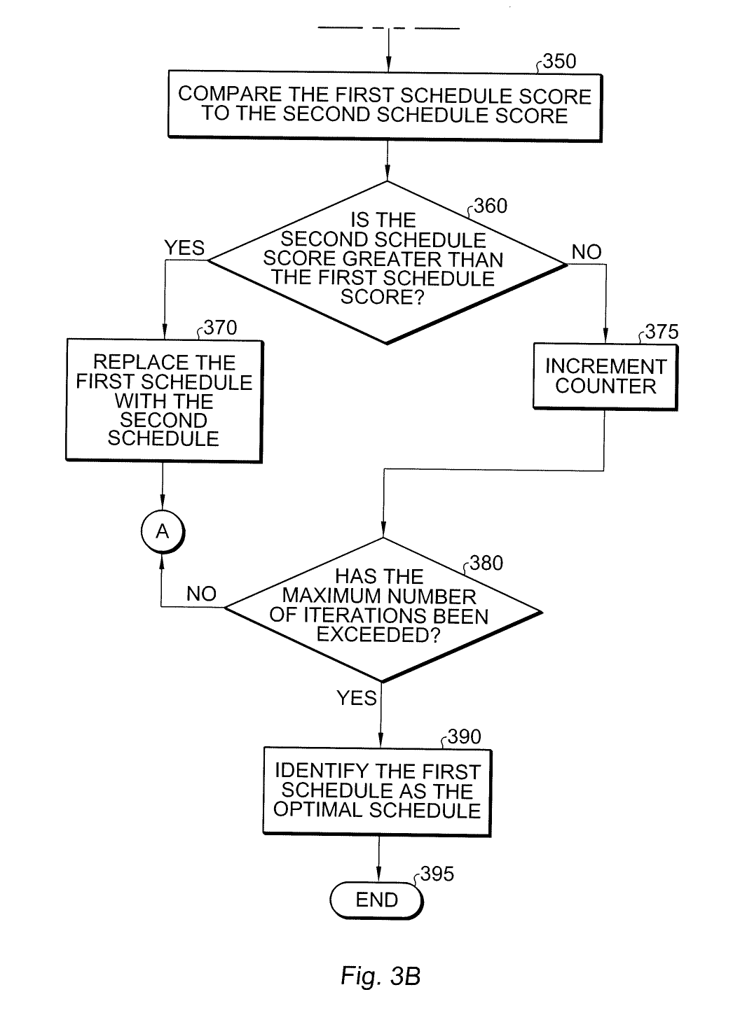

FIG. 3 is a flowchart illustrating methods of implementing an exemplary process for the Gradient Descent Optimization Process according to the present invention. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

The flowchart of FIG. 3 begins 305 with receiving 310 a task request. This request can be generated via a user interfacing with the task builder 150 via the user interface 120. Once the task has been generated constraints are retrieved 315 from persistent storage 130. These constraints include both hard and soft constraints associated with the task as well as hard and soft constraints associated with the resources from which the schedule generator 145 creates a viable schedule. For example, a task may have a hard constraint that the task be completed within 5 hours but preferably as soon as possible. Thus the hard constraint would be to have the task completed within 5 hours of the start of the schedule, with a soft constraint indicating that a schedule resulting in completion in less than 5 hours is more optimal than the longer alternative. Similarly the resource to meet the task is retrieved 320 from memory and also can possess hard and soft constraints. A resource may be used to complete the task but can only be used for a particular length of time, perhaps 3 hours (hard constraint) while it would be preferable if it was used for only 2 hours (soft constraint). While both hard constraints must be complied with for a legal schedule to be generated, the relative value of the soft constraints must be considered. For example, would it be more optimal to complete the task in 3 hours using the resource for 3 hours or to complete the task in 5 hours using the resource for only 2 hours. To accomplish this optimization each soft constraint is assigned or associated with an importance indicator.

Once the constraints have been retrieved 315 a schedule is generated by the builder engine 110 using a subset of the retrieved resources. The builder engine 110 picks and chooses from among the available resources to build a first schedule 325 that will meet all hard constraints. Once built the first schedule is scored 330 according to the compliance of each soft constraint.

The builder engine 110 then modifies one or more parameters of the schedule to form 335 a second schedule. The second schedule's compliance with all hard constraints is verified. According to one embodiment of the present invention, the modified parameter(s) are chosen by the builder engine 110 based on each soft constraint's importance to the schedule. The most important resource or task constraint is modified first. In other embodiments the selection and amount of modification may be random or selected based on predetermined criteria. In another embodiment several constraints can be modified at once or according to a specific pattern. In yet another embodiment of the present invention, the Probabilistic Schedule Build Process described above is utilized to select a modification or set of modifications to be attempted in each iteration.

Once the first schedule is modified so as to form a second schedule 335, the second schedule is scored 340. The score of the first schedule and that of the second schedule is then compared 350. An inquiry is made 360 whether the score of the second schedule is greater (indicating a more optimal schedule) than that of the first schedule. When the answer is yes, the second schedule replaces 370 the first schedule and the process returns to the step in which one or more attributes of the first schedule is modified 335.

When the inquirer determines that the second schedule is not greater than the first schedule, a counter is incremented 375 and the process determines 380 whether the predetermined number of iterations in which the second (modified) schedule's score has failed to exceed the first schedule's score has been reached. When the predetermined number of iterations has not been reached, the process once again returns to the modification step 335 and an attribute of the first schedule is modified. When the number of iterations has been exceeded, the process identifies 390 the first schedule as the final or optimal schedule ending 395 the process. The speed of convergence and degree of optimization can be controlled by the number of iterations and the basis on which the modifications are made. As can be appreciated by one skilled in the art, a trade off is made between how long the process iterates and the incremental increase on each iteration. In another embodiment of the present invention, the comparison and determination of whether to replace the first schedule by the second may be a range, and, while the second schedule replaces the first, a small incremental increase may increment the counter ultimately resulting in the termination of the process.

To better understand the utility and usefulness of the present invention, the following example is provided for review. Consider that a single task is requested to be accomplished and is governed by a plurality of constraints using a plurality of resources. Using an iterative approach to modify a schedule as previously described, an enumerated list of modifying actions on a single task is provided. These modifying actions include: a) move the task to an earlier time; b) move the task to a later time; c) move the task to a specified time X; d) substitute resource Y for X (X being not currently scheduled for the task); and e) add another resource to accomplish the task, and remove a resource.

Assume a simple schedule is generated and that thereafter the present invention is attempting to optimize the schedule. The schedule involves one week's worth of time, where each day has a morning shift and an evening shift for 14 shifts total (i.e., tasks). There are 4 people (resources), Alice, Bob, Charlie and Dave, who can be used to create the schedule. Each of these people have soft constraints associated with them, indicating how many shifts they should be scheduled for in the week, among other things. One such soft constraint specifies “Alice should be scheduled for between 4 and 5 shifts per week.”

Assume several iterations of the schedule have occurred and the current modification to the schedule is examining a schedule wherein Alice is only scheduled for 3 shifts. Assume further that the process is at the schedule modification step and is attempting to make the current schedule meet the soft constraint above (that Alice is scheduled for 4-5 shifts).

In this very simple example there are over 3000 ways to give Alice 4 or 5 shifts. There are millions of ways to schedule all 4 people to the 14 tasks. Due to combinatorial complexity it is too expensive to evaluate all possible modifications at each iteration.

Rather than evaluating all possible ways to build the schedule, or even all possible ways to modify a schedule, the present invention makes “informed” choices as to which of the possible modifications warrant investigation. These choices are based on information gathered that indicates what choices have the best chances of success in leading to a better schedule. For example, as a particular schedule is scored, the process gains data about what makes a high scoring schedule. The process may learn, for example, that Bob needs to pick up more shifts, Charlie has the right amount of shifts, and Dave has too many shifts. A flag or state variable can be set indicating these facts.

The present invention, therefore, considers which modifications should be examined in order to satisfy the soft constraint dealing with Alice's shifts. Based on the state variables previously described, the system determines an improved schedule is more likely by taking some shifts from Dave.

At this point the present invention considers a plurality of possible modifications to the existing schedule. These modifications can include: Swap Dave for Alice Monday, PM and Swap Charlie for Alice Thursday A.M.; Swap Dave for Alice Wednesday AM.; Swap Charlie for Alice Saturday AM; etc.

The present invention selects one of these modifications and applies the changes specified. The selection is based upon an estimate of the modification's chance to succeed in improving the schedule. A probability distribution is formed over the possible modifications from which the selection is drawn. For purposes of simplicity, consider generating only three possible modifications as listed above. A five point scale can demonstrate the probability estimation, with 1 meaning low chance of success and 5 meaning high chance of success. The first modification is assigned a 4 on the probability estimation scale since it involves swaps with Dave only, but is not the best option as it involves two discrete changes and hence has a higher chance of conflicts. The second modification is assigned a 5 on the probability estimation scale since it is a single swap with Dave. The third modification is given a 3 rating since it tries to swap with Charlie who already has the correct amount of shifts.

The ratings are normalized such that 42% of the time the present invention chooses the first modification, 33% of the time it chooses the second modification, and 25% of the time the third modification is chosen.

From the probability distribution a modification is selected. Once selected the changes are applied and the resulting schedule is scored. The process continues by determining whether the new schedule is an improvement.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention.

While there have been described above the principles of the present invention in conjunction with specific scheduling architecture, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A method for resource scheduling, the method comprising:
receiving a request to accomplish a task by using a plurality of resources;
retrieving from a memory constraints associated with the task, wherein constraints includes hard constraints and soft constraints;
creating a first schedule for use of a subset of the plurality of resources to accomplish the task wherein the first schedule complies with each hard constraint;
determining a first schedule score based on soft constraint compliance by the first schedule;
modifying the first schedule to form a second schedule wherein the second schedule complies with each hard constraint;
determining a second schedule score associated with the second schedule based on soft constraint compliance by the second schedule; and
selecting an optimal schedule by comparing the first schedule score to the second schedule score.

2. The method of claim 1 wherein each of the plurality of resources is associated with resource constraints.

3. The method of claim 1 wherein resource constraints include hard resource constraints and soft resource constraints.

4. The method of claim 1 wherein basis of the first schedule score includes compliance with soft resource constraints.

5. The method of claim 1 wherein basis of the second schedule score includes a degree of compliance with soft resource constraints.

6. The method of claim 5 wherein soft resource constraints include a resource importance indicator.

7. The method of claim 6 wherein the resource importance indicator for each soft resource constraint reflects that soft resource constraint's influence on schedule scores.

8. The method of claim 6 wherein a portion of the basis of the first and second schedule score is based on a combination of the resource importance indicator and the degree of compliance of each soft resource constraint of each resource used to accomplish the task.

9. The method of claim 1 wherein hard resource constraints must be complied with for the resource to be scheduled to accomplish the task.

10. The method of claim 1 wherein hard constraints include mandatory task requirements.

11. The method of claim 1 wherein violation of at least one hard constraint will result in schedule failure.

12. The method of claim 1 wherein soft constraints include optional requirements.

13. The method of claim 1 wherein each soft constraint includes an importance indicator.

14. The method of claim 13 wherein the importance indicator for each soft constraint reflects that soft constraint's influence on schedule scores.

15. The method of claim 14 wherein a portion of the basis of the first and second schedule score is based on a combination of the importance indicator and a degree of compliance of each soft constraint of each resource used to accomplish the task.

16. The method of claim 1 wherein modifying includes altering the subset of the plurality of resources associated with accomplishing the task.

17. The method of claim 1 wherein modifying includes changing at least one attribute of at least one resource of the subset of plurality of resources associated with accomplishing the task.

18. The method of claim 1 wherein selecting includes the first schedule score exceeding the second schedule score for a predetermined number of modifying iterations.

19. The method of claim 1 further comprising, responsive to the second schedule score exceeding the first schedule score, iteratively replacing the first schedule with the second schedule and repeating the modifying step.

20. The method of claim 19 wherein the task is associated with time including a start time and a duration of time over which the task is accomplished.

21. The method of claim 19 wherein repeating includes altering time associated with the task.

22. The method of claim 19 wherein repeating includes changing the subset of the plurality of resources.

23. The method of claim 19 wherein changing is based on a probability of creating an improved first schedule.

24. A method for resource scheduling, the method comprising:
generating a first schedule for use of a plurality of resources to accomplish a task wherein the first schedule complies with a plurality of requirements and satisfies a degree of desired conditions; and
modifying the first schedule to create a second schedule wherein the degree of satisfied desired conditions of the second schedule as compared to the first schedule is increased while compliance with the plurality of requirements by the second schedule is maintained.

25. The method of claim 24 wherein responsive to the second schedule's degree of satisfied desired conditions being larger than the first schedule's degree of satisfied desired conditions, replacing the first schedule with the second schedule.

26. The method of claim 25 wherein modifying continues iteratively until the second schedule's degree of satisfied desired conditions fails to be larger than the first schedule's degree of satisfied desired conditions for a predetermined number of iterations.

27. The method of claim 24 wherein modifying includes changing the plurality of resources used to accomplish the task.

28. The method of claim 24 wherein modifying includes changing an attribute of at least one of the plurality of resources used to accomplish the task.

29. A computer system for resource scheduling, the computer system comprising:
a machine capable of executing instructions embodied as software; and
a plurality of software portions stored in a memory, wherein:
one of said software portions is configured to receive a request to accomplish a task using a plurality of resources;
one of said software portions is configured to retrieve from a memory constraints associated with the task, wherein constraints includes hard constraints and soft constraints;
one of said software portions is configured to create a first schedule for use of a subset of the plurality of resources wherein the first schedule complies with each hard constraint;
one of said software portions is configured to determine a first schedule score based on soft constraint compliance by the first schedule;
one of said software portions is configured to modify the first schedule to form a second schedule wherein the second schedule complies with each hard constraint;
one of said software portions is configured to determine a second schedule score associated with the second schedule based on soft constraint compliance by the second schedule; and
one of said software portions is configured to select an optimal schedule by comparing the first schedule score to the second schedule score.
